(19) United States
(12) Patent Application Publication
(10) Pub. No.: US 2021/0109885 A1
(43) Pub. Date: Apr. 15, 2021

(54) DEVICE FOR MANAGING HDD BACKPLANE

(71) Applicant: Shenzhen Fugui Precision Ind. Co., Ltd., Shenzhen (CN)

(72) Inventors: LI-WEN GUO, Shenzhen (CN); KE-FENG YOU, Shenzhen (CN)

(73) Assignee: Shenzhen Fugui Precision Ind. Co., Ltd., Shenzhen (CN)

(21) Appl. No.: 16/671,677

(22) Filed: Nov. 1, 2019

(30) Foreign Application Priority Data
Oct. 11, 2019 (CN) 201910964161.5

(51) Int. Cl. G06F 13/42; G06F 3/06; G06F 1/04

(52) U.S. Cl. CPC G06F 13/4282; G06F 3/0634; G06F 2213/0026; G06F 3/0679; G06F 1/04; G06F 3/0658

(57) ABSTRACT

A device for managing an HDD backplane includes a mainboard and a backplane. The mainboard includes a first connector port and a second connector. The backplane includes a first HDD interface, a second HDD interface, an I2C selector, and a CPLD. The first and second HDD interfaces are both electrically connected to the CPLD. The first and second connector ports are both electrically connected to the I2C selector. The I2C selector is electrically connected to the CPLD. The CPLD receives an identification signal from the first HDD interface or the second HDD interface, and determines a type of HDD inserted in the first HDD interface or in the second HDD interface, and outputs a controlling signal to the I2C selector according to the type of HDD which is identified. The I2C selector turns on the first connector port and the second connector port according to the controlling signal.

### FIELD

The subject matter herein generally relates to HDD backplane management.

### BACKGROUND

A hard disk drive (HDD) backplane used in server systems requires both Non-Volatile Memory Express (NVME) HDD and Serial Advanced Technology Attachment (SATA)/Serial Attached SCSI (SAS) HDD. Currently, for cost reasons, most server systems use some interfaces to support NVME HDDs and most interfaces support SATA/SAS HDDs.

In addition, for the above traditional backplane, a separate integrated circuit (I2C) interface is usually required to implement management of the HDD backplane, which makes wiring traces complex and inflexible.

Therefore, there is room for improvement within the art.

### BRIEF DESCRIPTION OF THE DRAWING

Many aspects of the disclosure can be better understood with reference to the figure. The components in the figures are not necessarily drawn to scale, the emphasis instead being placed upon clearly illustrating the principles of the disclosure.

FIG. 1 is a block diagram of a device for managing HDD backplane according to an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

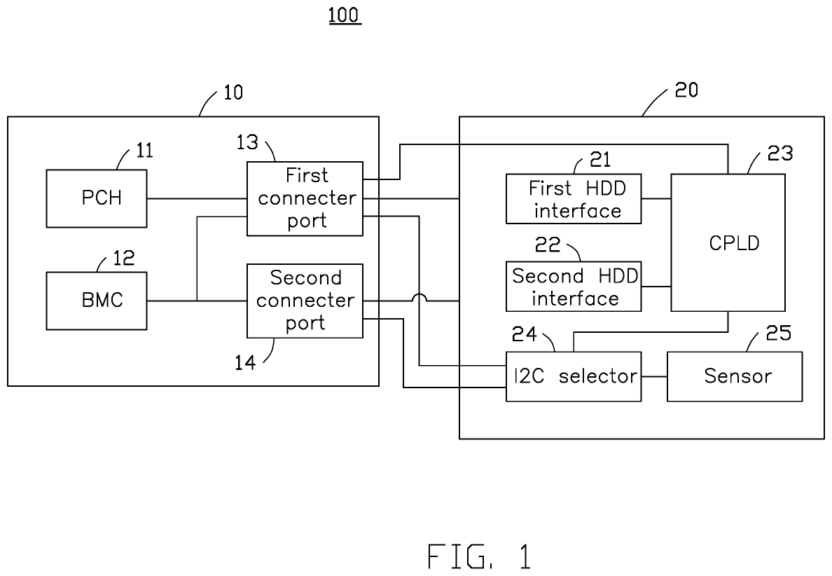

FIG. 1 illustrates a device for managing an HDD backplane (management device 100). The management device 100 includes a mainboard 10 and a backplane 20.

The mainboard 10 includes a baseboard management controller (BMC) 12, a first connecter port 13, and a second connecter port 14.

The BMC 12 is electrically connected to the first connector port 13 and the second connector port 14 through a connecting line, for example, I2C bus. The BMC 12 can read information of the backplane 20 through the first connector port 13 or the second connector port 14.

The first connector port 13 may be a Slimline connector port. The first connector port 13 can be electrically connected to the backplane 20 through a PCIE signal line for data transmission.

The second connector port 14 can be a MiniSAS connector port. The second connector port 14 can be electrically connected to the backplane 20 through a SATA/SAS signal line for data transmission.

The backplane 20 includes a first HDD interface 21, a second HDD interface 22, a Complex Programmable Logic Device (CPLD) 23, an integrated circuit (I2C) selector 24, and a sensor 25.

The first HDD interface 21 corresponds to a first type of HDD, such as an NVME HDD. When the first type of HDD is inserted in the first HDD interface 21, the first HDD interface 21 outputs a first identification signal.

The second HDD interface 22 corresponds to a second type of HDD, such as a SATA/SAS HDD. When the second type of HDD is inserted in the second HDD interface 22, the second HDD interface 22 outputs a second identification signal.

The CPLD 23 is electrically connected to the first HDD interface 21 and the second HDD interface 22 for respectively receiving the first identification signal and the second identification signal. The CPLD 23 is also electrically connected to the I2C selector 24. The CPLD 23 can determine, according to the received identification signal, for example the first identification signal or the second identification signal, whether a HDD is inserted in the backplane 20 and if so a type of the HDD inserted in the backplane 20. The CPLD 23 further outputs a first controlling signal or a second controlling signal to the I2C selector 24.

For example, when the CPLD 23 receives the first identification signal, the CPLD 23 determines that a first type of HDD is inserted in the first HDD interface 21. When the CPLD 23 receives the second identification signal, the CPLD 23 determines that a second type of HDD is inserted in the second HDD interface 22. If the CPLD 23 does not receive either first or second identification signals, the CPLD 23 determines that there is no HDD inserted in the backplane 20.

The I2C selector 24 is electrically connected to the CPLD 23, the first connector port 13, the second connector port 14, and the sensor 25 via an I2C bus. The I2C selector 24 selectively turns on the first connector port 13 or the second connector port 14 according to the first controlling signal or the second controlling signal output by the CPLD 23.

For example, when the first type of HDD is inserted in the first HDD interface 21, the CPLD 23 outputs the first controlling signal to the I2C selector 24. The I2C selector 24 receives the first controlling signal and turns on the first connector port 13. When the second type of hard disk is inserted in the second HDD interface 22, the CPLD 23 outputs the second controlling signal to the I2C selector 24. Then the I2C selector 24 receives the second controlling signal and turns on the second connector port 14.

The sensor 25 is electrically connected to the I2C selector 24. The sensor 25 includes, but is not limited to, a temperature sensor and a voltage sensor. The sensor 25 stores information of the backplane 200, such as a state of the backplane 200, types of HDDs inserted in the backplane 200, a temperature of the backplane 200, a voltage of the backplane 200, and so on.

In this embodiment, when the I2C selector 24 turns on the first connector port 13 or the second connector port 14, the BMC 12 can read the backplane information stored in the sensor 25 through the first connector port 13 or the second connector port 14, and the I2C selector 24, thereby effectively managing the backplane 20 through the BMC 12.

For example, when the first HDD interface 21 receives the first type of HDD, the first HDD interface 21 outputs the first identification signal to the CPLD 23. According to the received first identification signal, the CPLD 23 determines that the first type of HDD is inserted in the first HDD interface 21 and outputs the first controlling signal to the I2C selector 24. At the same time, the I2C selector 24 receives the first controlling signal from the CPLD 23 and turns on the first connector port 13. Then the BMC 12 reads, through the first connector port 13 and the I2C selector 24, the backplane information stored in the sensor 25, thereby effectively managing the backplane 20.

When the second HDD interface 22 receives the second type of HDD, the second HDD interface 22 outputs the second identification signal to the CPLD 23. According to the received second identification signal, the CPLD 23 determines that the second type of HDD is inserted in the second HDD interface 22 and outputs the second controlling signal to the I2C selector 24. At the same time, the I2C selector 24 receives the second controlling signal from the CPLD 23 and turns on the second connector port 14. Then the BMC 12 reads, through the second connector port 14 and the I2C selector 24, the backplane information stored in the sensor 25, thereby effectively managing the backplane 20.

In addition, when an HDD is not inserted in either the first HDD interface 21 or the second HDD interface 22, the I2C selector 24 does not turn on the first connector port 13 or the second connector port 14, then the mainboard 10 does not work.

In this embodiment, the mainboard 10 further includes a Platform Control Hub (PCH) 11. The PCH 11 is electrically connected to the first connector port 13 through a clock signal line. The PCH 11 is configured to output a clock (CLK) signal to the first connector port 13. The clock signal is configured to control the first connector port 13 to perform data transmission through a PCIE signal line.

In this embodiment, the CPLD 23 is further electrically connected to the first connector port 13. When the CPLD 23 receives the first identification signal, this indicates that the first type of HDD is inserted in the first HDD interface 21. Then the CPLD 23 further outputs the first controlling signal to the first connector port 13. That is, when the CPLD 23 receives the first identification signal, the CPLD 23 outputs the first controlling signal to the first connector port 13 and the I2C selector 24.

When the first connector port 13 receives the first controlling signal, the PCH 11 outputs the clock signal, through the clock signal line, to the first connector port 13. Then the first connector port 13 performs data transmission through the PCIE signal line. If the first connector port 13 does not receive the first controlling signal, the PCH 11 does not output the clock signal and the PCH 11 is in a sleep state.

It is believed that the embodiments and their advantages will be understood from the foregoing description, and it will be apparent that various changes may be made thereto without departing from the scope of the disclosure or sacrificing all of its advantages, the examples hereinbefore described merely being illustrative embodiments of the disclosure.

1. A device for managing A Hard Disk Drive (HDD) backplane, the device comprising:
a mainboard, the mainboard comprising a first connector port and a second connector port; and
a backplane, the backplane comprising a first HDD interface, a second HDD interface, an integrated circuit (I2C) selector, and a Complex Programmable Logic Device (CPLD), the first HDD interface being configured to receive a first type of HDD, the second HDD interface being configured to receive a second type of HDD, each of the first HDD interface and the second HDD interface being electrically connected to the CPLD, each of the first connector port and the second connector port being electrically connected to the I2C selector, the I2C selector being electrically connected to the CPLD,
wherein the CPLD receives an identification signal from the first HDD interface or the second HDD interface, determines a type of HDD inserted to the first HDD interface or the second HDD interface, and outputs a controlling signal to the I2C selector according to the type of HDD, and
wherein the I2C selector turns on the first connector port and the second connector port according to the controlling signal output by the CPLD;
the backplane further comprises a sensor, the sensor is electrically connected to the I2C selector and stores the information of the backplane, the mainboard reads the information of the backplane stored by the sensor through the I2C selector and one of the first connector port and the second connector port, which is turned on.

2. The device of claim 1, wherein the mainboard further comprises a Baseboard Management Controller (BMC), the BMC is electrically connected to each of the first connector port and the second connector port, and the BMC reads information of the backplane through the first connector port or the second connector port which is turned on.

3. (canceled)

4. The device of claim 1, wherein the first type HDD is a Non-Volatile Memory Express (NVME) HDD, the second type HDD is a Serial Advanced Technology Attachment (SATA)/Serial Attached SCSI (SAS) HDD.

5. The device of claim 4, wherein the first connector port is electrically connected to the I2C selector through a Peripheral Component Interconnect Express (PCIE) signal line for data transmission, the second connector port is electrically connected to the I2C selector through a SATA/SAS signal line for data transmission.

6. The device of claim 4, wherein when the first type of HDD is inserted in the first HDD interface, the first HDD interface outputs a first identification signal to the CPLD, the CPLD determines the type of HDD inserted to the first HDD interface and outputs a first controlling signal to the I2C selector, and the I2C selector turns on the first connector port according to the first controlling signal output by the CPLD.

7. The device of claim 4, wherein when the second type of HDD is inserted in the second HDD interface, the second HDD interface outputs a second identification signal to the CPLD, the CPLD determines the type of HDD inserted to the second HDD interface and outputs a second controlling signal to the I2C selector, and the I2C selector turns on the second connector port according to the second controlling signal output by the CPLD.

8. The device of claim 6, wherein the CPLD is further electrically connected to the first connector port and outputs the first controlling signal to the first connector port.

9. The device of claim 8, wherein the mainboard further comprises a Platform Control Hub (PCH), the PCH is electrically connected to the first connector port through a clock signal line, when the first connector port receives the first controlling signal, the PCH outputs a clock signal to the first connector port to control the first connector port to perform data transmission through a Peripheral Component Interconnect Express (PCIE) signal line.

10. A device for managing a Hard Disk Drive (HDD) backplane, the device comprises:
a first connector port;
a second connector port;
a first HDD interface, the first HDD interface configured to receive a first type of HDD;
a second HDD interface, the second HDD interface configured to receive a second type of HDD;
an integrated circuit (I2C) selector, the I2C selector electrically connected to the first connector port and the second connector port; and
a Complex Programmable Logic Device (CPLD), the CPLD electrically connected to the first HDD interface, the second HDD interface, and the I2C selector;
wherein the CPLD receives an identification signal from the first HDD interface or the second HDD interface, determines a type of HDD inserted to the first HDD interface or the second HDD interface, and outputs a controlling signal to the I2C selector according to the type of HDD; and
wherein the I2C selector turns on the first connector port and the second connector port according to the controlling signal
the backplane further comprises a sensor, the sensor is electrically connected to the I2C selector and stores the information of the backplane, the mainboard reads the information of the backplane stored by the sensor through the I2C selector and one of the first connector port and the second connector port, which is turned on.

11. The device of claim 10, further comprising a Baseboard Management Controller (BMC), wherein the BMC is electrically connected to the first connector port and the second connector port, and the BMC reads information of a backplane through the first connector port or the second connector port which is turned on.

12. (canceled)

13. The device of claim 10, wherein the first type HDD is a Non-Volatile Memory Express (NVME) HDD, the second type HDD is a Serial Advanced Technology Attachment (SATA)/Serial Attached SCSI (SAS) HDD.

14. The device of claim 13, wherein the first connector port is electrically connected to the I2C selector through a Peripheral Component Interconnect Express (PCIE) signal line for data transmission, the second connector port is electrically connected to the I2C selector through a SATA/SAS signal line for data transmission.

15. The device of claim 13, wherein when the first type of HDD is inserted in the first HDD interface, the first HDD interface outputs a first identification signal to the CPLD, the CPLD determines the type of HDD inserted to the first HDD interface and outputs a first controlling signal to the I2C selector, and the I2C selector turns on the first connector port according to the first controlling signal.

16. The device of claim 13, wherein when the second type of HDD is inserted in the second HDD interface, the second HDD interface outputs a second identification signal to the CPLD, the CPLD determines the type of HDD inserted to the second HDD interface and outputs a second controlling signal to the I2C selector, and the I2C selector turns on the second connector port according to the second controlling signal.

17. The device of claim 15, wherein the CPLD is further electrically connected to the first connector port and outputs the first controlling signal to the first connector port.

18. The device of claim 17, further comprising a Platform Control Hub (PCH), the PCH is electrically connected to the first connector port through a clock signal line, when the first connector port receives the first controlling signal, the PCH outputs a clock signal to the first connector port to control the first connector port to perform data transmission through a Peripheral Component Interconnect Express (PCIE) signal line.
